(19) United States
(12) Patent Application Publication
(10) Pub. No.: US 2026/0251515 A1
(43) Pub. Date: Aug. 27, 2026

(54) OPERATION OF A TRAILING CABLE

(71) Applicant: Innomotics GmbH, 90441 Nürnberg (DE)

(72) Inventors: MARKUS GAEBELE, Chirnside Park (AU); HELMAR JUNGFER, Erlangen (DE); THOMAS SCHINDLER, Rosstal (DE); CRISTIANO DE BONI, Ulm (DE); ANDREA TURCATI, München (DE)

(73) Assignee: Innomotics GmbH, 90441 Nürnberg (DE)

(21) Appl. No.: 18/870,584

(22) PCT Filed: May 31, 2023
(86) PCT No.: PCT/EP2023/064553

§ 371 Date: Nov. 29, 2024

(30) Foreign Application Priority Data
May 31, 2022 (EP) 22176480.6

(51) Int. Cl. G01L 5/101; G01L 5/105

(52) U.S. Cl. CPC G01L 5/101; G01L 5/105

(57) ABSTRACT

In a method for operating a cable, a sensor arranged in the cable generates sensor signals, when the sensor detects a use of the cable. The sensor signals are evaluated based on operating data relating to past and/or future data and a characteristic is produced for the cable based on the sensor signals.

The invention relates to a method for operating a cable, in particular a trailing cable.

Operation concerns monitoring, fault prediction or operational optimization of the trailing cable, The trailing cable is used in particular for an HVILV power supply. HV stands for High Voltage. LV stands for Low Voltage. Trailing cables are regularly used in moving applications. Moving applications can be found, for example, in cranes, in particular in port facilities, in mining or in stockpiles.

Moving applications, in particular with a high-voltage supply on board, which is provided via a coiled cable, have cable damage as one of the frequent causes of failure, caused by an unfavorable mechanical load, in particular triggered by incorrect cable routing and/or unsuitable operation of the application. This can lead to an application failure due to a mechanical load on a cable, which leads to electrical damage. The load reflects the use of the cable. An application failure is understood to mean, for example, the failure of a crane, a belt conveyor, an excavator, such as a lignite excavator, etc. The application failure can therefore mean the failure of a technical system or the partial failure of a technical system. The mechanical load of a cable, an electrical cable, can be monitored or measured. This means that the use of the cable is also monitored or measured. In particular, the load is a measure of usage. For example, a cable, Le. an electrical cable, can have an optical waveguide. The mechanical load can be measured with the help of this optical waveguide integrated into the cable.

One object of the invention is to use information about the load on the cable, in particular the electrical cable, advantageously for the operation of the cable, the cable being in particular a trailing cable.

The object can be achieved in a method according to claim 1 and an apparatus according to claim 9. Further developments will emerge, for example, according to claims 2 to 8.

In a method for operating a cable, the cable has a sensor for detecting a use, in particular a load, of the cable, sensor signals being stored, a characteristic for the cable being produced by means of the sensor signals, operating data being used to evaluate the sensor signals, the operating data relating in particular to past and/or future data, which depend in particular on the torque and/or the speed of a cable drum. Data which depends on the torque and/or the speed of a cable drum is, for example, the speed of movement of the cable, the tension on or in the cable, but also the torque and/or the speed of the cable drum itself. By means of the cable drum, the cable can be wound or unwound.

In one embodiment of the method, stress on the cable is predicted. This prediction is based in particular on current data of the cable, which in particular takes into account a stress already applied to the cable, as well as on data for a future use of the cable, depending on the planned use. Thus, the prediction, which is a simulation of the future, takes into account in particular future winding processes and/or future speeds for the winding process and/or future torques of the cable drum and/or future tensile forces on the cable. If, for example, the simulation shows that the simulated service life of the cable is shorter than the planned service life, an earlier replacement of the cable can be planned and/or the stress on the cable can be reduced. Reduced stress on the cable can be achieved, for example, by reducing the number of winding processes and/or by reducing the speed at which the cable is wound or unwound.

In one embodiment of the method, a plurality of characteristics are determined at different times, the characteristics being evaluated together. A sensor is also to be understood here as an element of a sensor. A sensor element is, for example, an optical waveguide. In this case, for example, a light source and/or a semiconductor for detecting light can also be regarded as belonging to the sensor, The characteristic is in particular a date or a data set. The characteristic also relates to the use or load of the cable. The sensor has, for example, a glass fiber. With the aid of the sensor, for example, twisting, bending, stretching and/or compression of the cable can be detected. These are circumstances which affect the use of the cable. In particular, the location of twisting, bending, stretching and/or compression of the cable can also be detected. The location concerns a position on the cable. Thus, for example, 3 meters or 58 meters away from the beginning or end of the cable.

This means that not only the mechanical load of the cable can be measured, but a warning light goes on if the limit value is exceeded. By storing the characteristics of a cable at different times, a trend/development of the integrity of the cable can be carried out. It is even possible to predict further stress on the cable and thus, for example, also its wear or failure when future use is simulated. This means, for example, that the number of operating cycles of a system with the monitored cable is specified and the effects this has on the cable can be calculated. This not only enables condition monitoring of the cable, but also a prediction. This helps to implement the predictive maintenance approach. This is achieved in particular by using a correlation of the data about the cable to the application in which the cable is used. Thus, predictive properties, Le, predictions, can be made about the cable. These properties can be obtained in particular with a cable which has an integrated optical waveguide. In this way, mechanical loads of an HV cable can be measured. The measurement of a mechanical load on optical waveguides is based, for example, on a changing wavelength of the reference wavelength of the measurement signal.

By evaluating the characteristics, various functionalities can be achieved, such as:
Early detection of an incorrect load on the cable, which later triggers or can trigger damage,
Recognition of a connection between the operation of an application or production behavior and the cable which is used,
Optimization of the operation of an application to avoid cable damage,
Detection of an application error based on the mechanical measurement and/or
A determination of the remaining service life of the cable based on the operating data of the application and the load data of the cable.

The characteristic is a kind of fingerprint of the cable. This allows a wide range of functionalities to be generated.

In one embodiment of the method, the characteristic of the cable relates to at least 80% of the length of the cable. The characteristic can also relate to the entire length of the cable. For example, a fingerprint of the cable, which relates to or Is the measurement signal of the sensor, can be recorded over the entire length of the cable. The recording takes place, for example, at fixed time intervals (e.g. every minute, every hour, every day, every month, etc.) and/or in certain operating states (e.g. the cable is at rest, the cable is moving, the cable is wound, the cable is unwound, etc.). For example, the fingerprint, i.e. the characteristics, of the cable can change over the first 3 months after commissioning due to the mechanical winding and unwinding load. The development of the fingerprint (in particular the development of the characteristics) can be simulated and/or predicted from the beginning, so that a statement about the condition of the cable is possible from day one. For simulation or prediction, in particular the number of winding and unwinding movements of the cable on a cable drum is taken into account. Thus, the expected future application (i.e. the application, use, or utilization), I.e. the expected future operation, is taken into account in the prediction of cable data (e.g. wear, durability, etc.). These functionalities described can of course not only be used after 3 months from commissioning, but also at other times of different length. For example, it can be determined whether a failure of the cable is to be expected by the next expected maintenance interval and with an expected specified use/application, or whether this will occur with a certain probability. For example, it can be determined whether, in the event of a change in use (e.g. slower winding or unwinding), the expected failure can be delayed (in particular how long).

In one embodiment of the method, a characteristic is simulated, the simulation depending on a predeterminable expected use of the cable. Measurement data from the sensor, or variables derived therefrom, are used as input variables for the simulation. These are, for example, load, time, step sequence and asset data. Asset data is data from the system in which the cable is used. Asset data can also be referred to as operating data. Application data is also operating data. Asset data is, for example, mechanical variables, such as cable drum diameter, number of cable layers, mechanical cable data, as well as application operating data, such as direction of movement and speed of the asset (system or system object), torque and/or speed of the cable drum. The application data is correlated, for example, with cable stress values (these are represented by the characteristics) in order to detect any dependencies.

In one embodiment of the method, wear of the cable is predicted. This makes it easier to plan maintenance intervals.

In one embodiment of the method, an anomaly of the cable is detected. For example, the location of a failure of the cable can be detected at an early stage. In order to extend the service life of the cable, the cable can be protected in the future, for example at the location where the anomaly was detected. For example, at certain positions, the cable can be gently slowed down (e.g. wound up or unwound).

In one embodiment of the method, anomalies can be detected at an early stage based on an algorithm. In addition, by aggregating the anomalies or stress load as a function of intensity and frequency, the remaining service life can be simulated, which is a function of the previous operating characteristics, for example from day 1 of operation, or maintenance, or repair,

In one embodiment of the method, operating data, which is particularly application-specific, is also used to evaluate the characteristics. The additional correlation with the operating data shows, for example, optimum operating conditions and allows production optimization. Early detection of anomalies enables passive intervention (e.g. informing the operator that the production speed is too high). Early detection of anomalies therefore allows situations that would lead to failure to be detected at an early stage, allowing an operator to adjust operations in good time.

In one embodiment of the method, incorporating or using the application data, e.g. torque or cable position, makes it possible to link the condition causing potential cable damage with any problematic operating data and to geographically localize the fault and the fault situation. This goes beyond a pure condition monitoring solution, which can only look into the past but cannot detect a fault at an early stage.

In one embodiment of the method, a statement about the condition of the cable is brought into the context of the operation of the application, so that it is easier to determine the cause and no additional on-site observation may be necessary. Even invisible faults can be detected. Automatic detection and/or information to the operator and recommendations for action are now also possible.

In a system with a cable, in particular a trailing cable, for electrical power supply, the trailing cable has a sensor in the cable, sensor signals being evaluable, an evaluation facility being provided for carrying out a method of the type described.

The invention is illustrated and explained in more detail hereinafter with reference to figures. The figures show

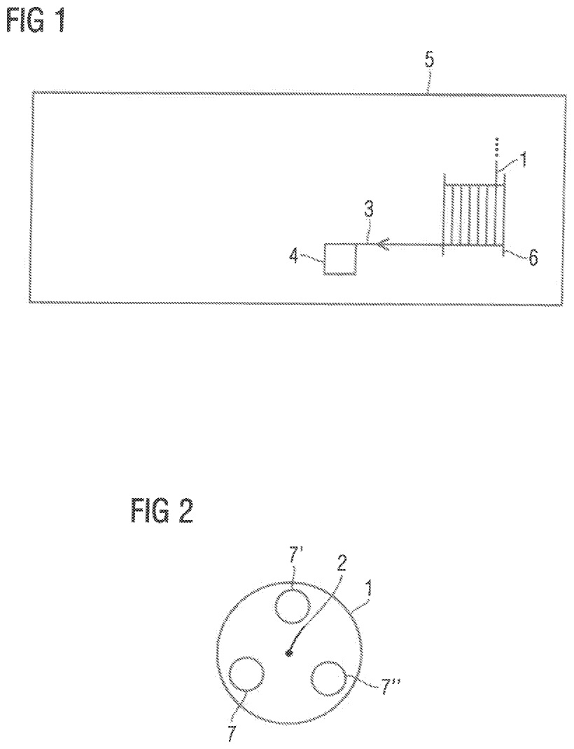

FIG. 1 a system with a trailing cable, and

FIG. 2 a cable.

The illustration according to FIG. 1 shows a system 5. The system 5 is an industrial system, such as, for example a crane or a lignite excavator or the like. The system 5 has a cable drum 6 with a trailing cable (cable) 1. The cable 1 has a sensor, which is shown in FIG. 2. The sensor generates sensor signals 3, which are transmitted to an evaluation facility 4.

The illustration according to FIG. 2 shows a cable 1 which has electrical conductors 7, 7′and 7″. As a sensor or as a sensor element (element of a sensor), the cable 1 has an optical waveguide 2. Such a cable 1 can be monitored using one of the methods described.

1.-9. (canceled)

10. A method for operating a cable, the method comprising:
storing sensor signals generated by a sensor, when the sensor detects a use of the cable;
evaluating the sensor signals based on operating data relating to past and/or future data; and
producing a characteristic for the cable based on the sensor signals.

11. The method of claim 10, wherein the past and/or future data depend on a torque and/or speed of a cable drum.

12. The method of claim 10, further comprising predicting a stress on the cable.

13. The method of claim 10, further comprising:
determining a plurality of characteristics at different times; and
evaluating the plurality of characteristics together.

14. The method of claim 10, wherein the characteristic relates to at least 80% of a length of the cable.

15. The method of claim 10, further comprising simulating the characteristic depending on a predeterminable expected use of the cable.

16. The method of claim 10, further comprising predicting wear on the cable.

17. The method of claim 10, further comprising detecting an anomaly of the cable.

18. The method of claim 10, wherein the operating data are specific to an application of the cable for use in evaluating the sensor signals.

19. A system, comprising:
a cable for electrical power supply;
a sensor arranged in the cable for generating sensor signals when detecting a use of the cable; and
an evaluation facility designed to evaluate the sensor signals based on operating data relating to past and/or future data and to produce a characteristic for the cable based on the sensor signals.

20. The system of claim 19, wherein the cable is a trailing cable.

21. The system of claim 20, wherein the past and/or future data depend on a torque and/or speed of a cable drum.

22. The system of claim 20, wherein the evaluation facility is designed to predict a stress on the cable.

23. The system of claim 20, wherein the evaluation facility is designed to determine a plurality of characteristics at different times and to evaluate the plurality of characteristics together.

24. The system of claim 20, wherein the characteristic relates to at least 80% of a length of the cable.

25. The system of claim 20, wherein the evaluation facility is designed to simulate the characteristic depending on a predeterminable expected use of the cable.

26. The system of claim 20, wherein the evaluation facility is designed to predict wear on the cable.

27. The system of claim 20, wherein the evaluation facility is designed to detect an anomaly of the cable.

28. The system of claim 20, wherein the operating data are specific to an application of the cable when the evaluation facility evaluates the sensor signals.
